(19) United States
(12) Patent Application Publication
(10) Pub. No.: US 2026/0169947 A1
(43) Pub. Date: Jun. 18, 2026

(54) EXTERNAL DEVICE BANDWIDTH ADAPTATION

(71) Applicant: Aivres Systems Inc., San Jose, CA (US)

(72) Inventor: Chengwei LIN, New Taipei City (TW)

(21) Appl. No.: 18/986,168

(22) Filed: Dec. 18, 2024

(51) Int. Cl. G06F 13/42

(52) U.S. Cl. CPC G06F 13/4221; G06F 2213/0026

(57) ABSTRACT

One or more embodiments of the present specification provide external device bandwidth adaptation methods, apparatuses, and systems. Previous bandwidth allocation signal indicating bandwidth previously allocated for external devices of a central processing unit (CPU) in a computing device is maintained. Downstream ports of a peripheral component interconnect express (PCIe) controller of the CPU connect to respective cages which the external devices plug into. Upstream ports of the PCIe controller connect to respective PCIe ports of the CPU. After one of the external devices is replaced by a new external device that requires a different bandwidth, a present bandwidth signal from the cages is obtained. Whether the present bandwidth signal matches the previous bandwidth allocation signal is determined. In response to determining that the present bandwidth signal does not match the previous bandwidth allocation signal, a new allocation of the bandwidth for current external devices in the cages is caused.

### BACKGROUND

Computing devices, such as servers, are widely used in a variety of fields. In areas such as artificial intelligence (AI) and big data, the need for computing is growing rapidly. To improve flexibility and computational efficiencies, some computing devices are configured to include different external devices within the same server chassis, making the computing devices suitable for a variety of applications. For example, a computing device for AI applications can be configured to include one or more graphical processing units (GPUs). Storage servers can be configured to include one or more Non-Volatile Memory Express (NVMe) devices.

Some computing devices use a Peripheral Component Interconnect Express (PCIe) bus to connect the external devices to a motherboard. When a computing device is powered up, the computing device performs Basic Input/Output System (BIOS) initialization, and the bandwidth of the PCIe ports of a processor, such as a central computing unit (CPU), is allocated based on the bandwidth requirement of the external devices at the time of the power up, and is fixed after the BIOS initialization. However, when the computing device replaces one or more external devices with one or more other external devices that require different bandwidth allocation, the computing device must change the bandwidth of the PCIe ports of the processor. To change the bandwidth of the PCIe ports of a processor, the computing device needs to perform a reboot and needs to re-perform the BIOS initialization to adjust the bandwidth of the PCIe ports of the processor. Rebooting a server will interrupt current computation and services provided by a server, reducing the service continuity and availability of the systems.

### SUMMARY

The present disclosure describes systems and techniques to automatically adapt Peripheral Component Interconnect Express (PCIe) bandwidth for replacement of external devices with different bandwidth without a need to reboot a computing device.

In an implementation, previous bandwidth allocation signal indicating bandwidth previously allocated for external devices of a central processing unit (CPU) in a computing device is maintained by a complex programmable logic device (CPLD). Downstream ports of a peripheral component interconnect express (PCIe) controller of the CPU connect to respective cages which the external devices plug into following the previous bandwidth allocation signal. Upstream ports of the PCIe controller connect to respective PCIe ports of the CPU using a fixed allocation of bandwidth. After one of the external devices is replaced by a new external device that requires a different bandwidth, a present bandwidth signal from the cages is obtained by the CPLD. Whether the present bandwidth signal matches the previous bandwidth allocation signal is determined by the CPLD. In response to determining that the present bandwidth signal does not match the previous bandwidth allocation signal, a new allocation of the bandwidth for current external devices in the cages is caused by the CPLD. The current external devices include the new external device, and the downstream ports of the PCIe controller connect to the cages using the new allocation of bandwidth.

The described subject matter can be implemented using a computer-implemented method; a non-transitory, computer-readable medium storing computer-readable instructions to perform the computer-implemented method; and a computer-implemented system comprising one or more computer memory devices interoperably coupled with one or more computers and having tangible, non-transitory, machine-readable media storing instructions that, when executed by the one or more computers, perform the computer-implemented method/the computer-readable instructions stored on the non-transitory, computer-readable medium.

The subject matter described in this specification can be implemented to realize one or more of the following advantages. Described systems and techniques can accommodate changing external devices of a computing device with different PCIe bandwidth without a need to reboot the computing device. Thus, the systems and techniques allow the replacement of PCIe devices with different bandwidth without server downtime. Plug and play of external PCIe devices can be achieved without interrupting current computation and services provided by a server. The described systems and techniques can reduce downtime and maintenance costs of the server and also improve service continuity and availability of the server.

The details of one or more implementations of the subject matter of this specification are set forth in the Detailed Description, the Claims, and the accompanying drawings. Other features, aspects, and advantages of the subject matter will become apparent to those of ordinary skill in the art from the Detailed Description, the Claims, and the accompanying drawings.

### DESCRIPTION OF DRAWINGS

FIG. 1 is a block diagram of a computing device for automatically adapting Peripheral Component Interconnect Express (PCIe) bandwidth for replacement of external devices with different bandwidth without a need to reboot the computing device, according to an implementation of the present disclosure.

FIG. 2 is a block diagram of the computing device of FIG. 1, with replacement of several external devices, according to an implementation of the present disclosure.

FIG. 3 is a diagram of bandwidth allocation lines, according to an implementation of the present disclosure.

FIG. 4 is a flowchart illustrating an example of a computer-implemented method for external device bandwidth adaptation, according to an implementation of the present disclosure.

FIG. 5 is a block diagram illustrating an example of a computer-implemented system used to provide computational functionalities associated with described algorithms, methods, functions, processes, flows, and procedures, according to an implementation of the present disclosure.

Like reference numbers and designations in the various drawings indicate like elements.

### DETAILED DESCRIPTION

The following detailed description describes systems and techniques to automatically adapt Peripheral Component Interconnect Express (PCIe) bandwidth for replacement of external devices (e.g., hard drives, solid state drive (SSD), or optical disc) with different bandwidth without a need to reboot a computing device and is presented to enable any person skilled in the art to make and use the disclosed subject matter in the context of one or more particular implementations. Various modifications, alterations, and permutations of the disclosed implementations can be made and will be readily apparent to those of ordinary skill in the art, and the general principles defined can be applied to other implementations and applications, without departing from the scope of the present disclosure. In some instances, one or more technical details that are unnecessary to obtain an understanding of the described subject matter and that are within the skill of one of ordinary skill in the art may be omitted so as to not obscure one or more described implementations. The present disclosure is not intended to be limited to the described or illustrated implementations, but to be accorded the widest scope consistent with the described principles and features.

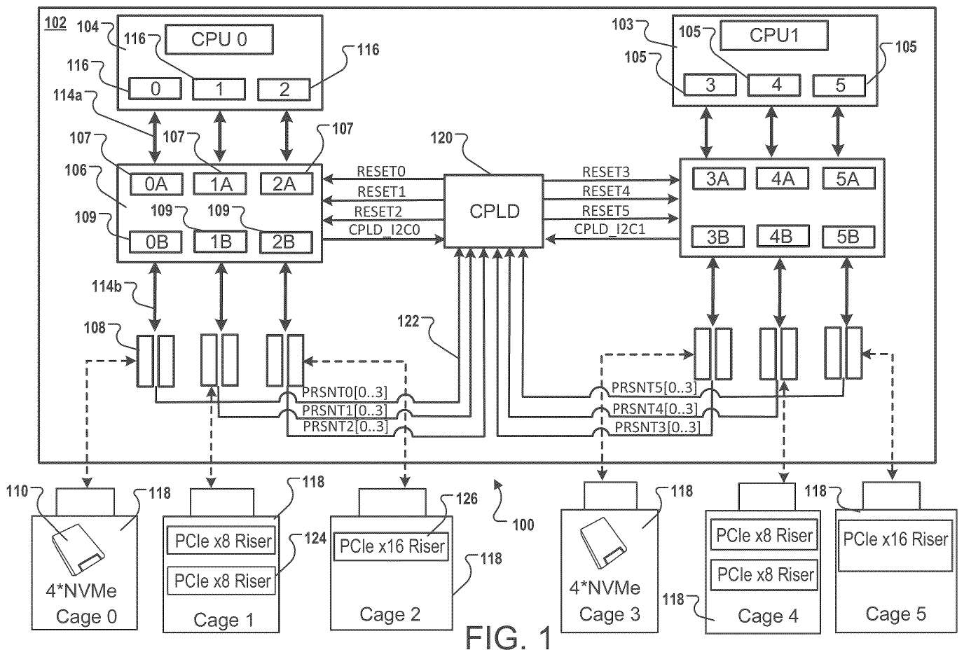

FIG. 1 is a block diagram of a computing device 100 for automatically adapting PCIe bandwidth for replacement of external devices with different bandwidth without a need to reboot the computing device 100, according to an implementation of the present disclosure. The computing device 100 includes a motherboard 102 that is the main circuit board that connects the computing device 100's internal components and external components, and allows them to communicate with each other. The motherboard 102 connects one or more processors, memory, graphics card, and other hardware.

The computing device 100 includes one or more processors. The one or more processors can be one or more central processing units (CPUs), graphics processing units (GPUs), multi-core processors, microprocessors, quantum processors, or a combination of these. For example, the motherboard 102 connects two CPUs, such as the CPU0 104 and CPU1 103. The CPU0 104 can include one or more PCIe ports 116. For example, the CPU0 104 includes three PCIe ports 116 numbered as port 0, port 1, and port 2, and the CPU1 103 includes three PCIe ports 105 numbered as port 3, port 4, and port 5. Although most of the descriptions below are using the example of CPUs, the described systems and techniques are applicable to other types of processors.

The computing device 100 uses PCIe topology to accommodate one or more external devices external to the motherboard 102. PCIe is a standardized interface that connects components to a computer's motherboard for high-speed data transfer. PCIe is used for connecting external devices 110 including expansion cards, such as graphics cards, network cards, storage controllers, to the motherboard 102. For example, the external devices of computing device 100 can include Non-Volatile Memory Express (NVMe) devices 110, PCIe x8 Riser cards 124, and PCIe x16 Riser cards 126. The external devices can have various bandwidth, such as x4, x8, or x16.

A PCIe bus 114 (including 114a and 114b) connects the CPU with one or more connectors 108, and each connector connects to an external device 110. In some implementations, the computing device 100 includes one or more cages 118 that can accommodate different types of PCIe devices 110. Each connector 108 connects to a cage 118 which an external device 110 plugs into. Each cage 118 can include a printed circuit board (PCB) that allows users to add, remove, or exchange various types of external devices 110. In some implementations, the cage 118 can include a PCIe slot that connects to the external device 110.

For example, the computing device 100 includes six cages. The CPU0 communicates with three cages, Cage0, Cage1, and Cage2. The CPU1 103 communicates with three cages, Cage3, Cage4, and Cage5. Four PCIe x4 NVMe devices 110 currently plug into the Cage0. Two PCIe x8 Riser cards currently plug into the Cage1. One PCIe x16 Riser card plugs into Cage2. In some implementations, the one or more cages 118 of the computing device 100 can have the same physical size to meet serviceability requirements for diverse PCIe device needs, providing a wider choice and more flexible configuration options.

The computing device 100 allocates bandwidth for the external devices 110 when the system is powered on. When the computing device 100 is powered up, the computing device 100 performs Basic Input/Output System (BIOS) initialization, and the bandwidth of the PCIe ports 116 of a processor, such as the CPU 104, is fixed after the BIOS initialization.

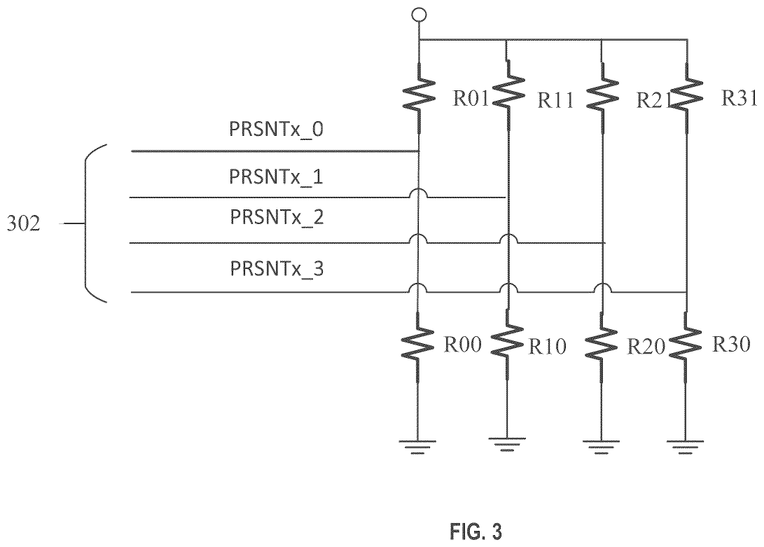

The one or more cages 118 can include respective PCBs that connect to different kinds of external devices 110. Each PCB in a cage 118 is connected to a set of bandwidth allocation lines 122. FIG. 3 is a diagram of bandwidth allocation lines, according to an implementation of the present disclosure. The computing device 100 determines whether signals RX0, RX1 should be loaded based on the bandwidth requirements of the external devices plugged into the cages, where X=0, 1, 2, 3. For example, The computing device 100 determines whether signals R00, R10, R20, R30, R01, R11, R21, and R31 should be loaded based on the bandwidth requirements of the four NVMe devices 110, the two PCIe x8 Risers 124, and the one PCIe x16 Riser 126 plugged into Cage0, Cage1, and Cage2. The value of signal RX1 is 1 when it is loaded, and the value of signal RX0 is 0 when it is loaded.

When the computing device 100 is powered on, the BIOS reads level information in the bandwidth allocation lines 122 (the lines 302 in FIG. 3), e.g., present signals PRSNTx_[0 . . . 3], and automatically configures the bandwidth allocation for the external devices using a bandwidth allocation table in Table 1. The external devices can have various bandwidth, such as x4, x8, or x16. The computing device 100 can use the bandwidth allocation table to determine the values for R0X, R1X, R2X, and R3X.

TABLE 1
Bandwidth Allocation Table

| R_{0X} | R_{1X} | R_{2X} | R_{3X} | | | | |
|---|---|---|---|---|---|---|---|
| 0 | 0 | 0 | 0 | x4 | x4 | x4 | x4 |

| | | | | | | |
|---|---|---|---|---|---|---|
| 0 | 0 | 0 | 1 | x4 | x4 | x8 |

| | | | | | | |
|---|---|---|---|---|---|---|
| 0 | 1 | 0 | 0 | x8 | x4 | x4 |

| | | | | | |
|---|---|---|---|---|---|
| 0 | 1 | 0 | 1 | x8 | x8 |

| | | | | |
|---|---|---|---|---|
| 1 | 1 | 1 | 1 | x16 |

For example, when the computing device 100 connects to four devices, each device having a x4 bandwidth requirement, the computing device 100 can allocate the bandwidth for the devices by setting R0X=0, R1X=0, R2X=0, R3X=0. When the computing device 100 connects to two devices with x4 bandwidth requirement and one device with x8 bandwidth requirement, the computing device 100 can allocate the bandwidth for the devices by setting R0X=0, R1X=0, R2X=0, R3X=1. When the computing device 100 connects to one x8 device and two x4 devices, the computing device 100 can allocate the bandwidth for the devices by setting R0X=0, R1X=1, R2X=0, R3X=0. When the computing device 100 connects to two x8 devices, the computing device 100 can allocate the bandwidth for the devices by setting R0X=0, R1X=1, R2X=0, R3X=1. When the computing device 100 connects to one x16 device, the computing device 100 can allocate the bandwidth for the devices by setting R0X=1, R1X=1, R2X=1, R3X=1. The value for the bandwidth allocation lines 122 (PRSNTx_[0 . . . 3]) can be automatically configured based on the values for ROX, R1X, R2X, and R3X using the bandwidth allocation lines in FIG. 3.

For example, a PCIe Contract Electronics Manufacturer (CEM) slot can be configured to connect to various types of external devices with various bandwidth, such as PCIe x8 bandwidth, PCIe x16 bandwidth, NVMe x4 bandwidth, Open Compute Project (OCP) network adapter card with x8 or x16 bandwidth, and other possible PCIe devices with different bandwidth. After the computing device 100 completes the BIOS initialization and configuration, the computing device 100 boots the operating system of the computing device 100 so that the computing device 100, e.g., a server, can function properly.

However, in some existing systems, the bandwidth allocation lines are directly connected to one or more CPUs. Thus, during BIOS initialization, these systems automatically configure the bandwidth of PCIe ports of the one or more CPUs according to the signals in the bandwidth allocation lines. After the BIOS initialization, the bandwidth of PCIe ports of the CPUs is fixed and cannot be changed without a system reboot. When the external devices are replaced with other external devices having different bandwidth, the bandwidth of the PCIe ports of the CPU cannot be switched dynamically and instantaneously. In these existing systems, if PCIe bandwidth redistribution is required, these existing systems need to reboot and perform the BIOS initialization again to determine the new bandwidth allocation. For example, these existing systems need to perform a PCIe enumeration to accommodate the new bandwidth requirements. Therefore, these existing systems cannot dynamically adapt to the changing bandwidth requirements of the external PCIe devices, and any new bandwidth allocation must be applied by restarting the systems.

The computing device 100 can automatically adapt PCIe bandwidth for replacement of external devices having different bandwidth without a need to reboot the computing device 100. Rather than directly connecting the bandwidth allocation lines to the CPU, the computing device 100 connects the bandwidth allocation lines 122 to a complex programmable logic device (CPLD) 120. In some implementations, instead of using a CPLD, the system can use a microcontroller, a system on a chip (SoC) device, or a field-programmable gate array (FPGA) device to connect to the bandwidth allocation lines 122. Rather than directly connecting the CPU to the connectors using a PCIe bus, the computing device 100 includes a PCIe controller 106 attached to the motherboard 102 and communicates with the CPLD. The PCIe controller 106 connects the CPU 104 and the connectors 108, and transmits data between the CPU 104 and the external devices 110 through the PCIe bus 114a and 114b. In some implementations, the PCIe controller 106 can be implemented using a suitable hardware device, such as a PCIe switch.

The PCIe controller 106 controls the bandwidth allocation for the external devices 110 and the PCIe ports 116 of the CPU 104. In some implementations, the PCIe controller 106 can control data transfer or communications between different components of the device 100. For example, if the external devices 118 associated with the same PCIe controller need to transfer data, the external devices 118 can transfer data using the PCIe controller 106, instead of using the CPU0 104. A first portion of the PCIe bus 114a connects the PCIe ports 116 of the CPU 104 and the PCIe controller 106, and a second portion of the PCIe bus 114b connects the PCIe controller 106 to the connectors 108. Each CPU can communicate with a respective PCIe controller that controls the external devices connected to that CPU. For example, the CPU0 can communicate with the PCIe controller 106, and the CPU1 103 can communicate with another PCIe controller. In some implementations, two or more processors can share the same PCIe controller. For example, CPU0 104 and CPU1 103 can share the same PCIe controller.

The PCIe controller 106 includes upstream ports 107 that connect to the CPU0 104, and downstream ports 109 that connect to the connector 108. For example, the PCIe controller 106 includes upstream ports 107 0A, 1A, and 2A that respectively connect to the PCIe ports 116 0, 1, and 2 of the CPU0 104. The computing device 100 can allocate a fixed bandwidth for the communication between the CPU0 104 and the PCIe controller 106. For example, the fixed bandwidth can be the maximum bandwidth of the PCIe ports 116 of the CPU0 104. In the example bandwidth allocation Table 1, the maximum bandwidth is x16, and the system can use the fixed x16 bandwidth for each of the ports 0, 1, and 2. When the computing device 100 is powered on, the BIOS initialization configures the bandwidth of the PCIe ports 116 of the CPU 104 using the fixed x16 bandwidth, independent of the bandwidth requirement of the external devices 110.

The PCIe controller 106 includes downstream ports 109 0B, 1B, and 2B that respectively connect to three connectors 108. The computing device 100 can transfer the PCIe signal through the PCIe bus 114a between the CPU 104 and the PCIe controller 106, and can transfer the PCIe signal through the PCIe bus 114b between the PCIe controller 106 and the connectors 108 (and with the various cages 118).

The CPLD 120 controls the bandwidth allocation for the downstream ports 109 of a PCIe controller 106 that connects to the connectors 108 for the external devices 110. As discussed herein, the upstream ports 107 of the PCIe controller 106 connect to the CPU 104 using a fixed allocation of bandwidth. Thus, no matter what kinds of bandwidth is needed for the external devices, the bandwidth for the PCIe ports 116 of the CPU 104 is fixed and the replacement of external devices having different bandwidth does not require a reboot of the computing device 100.

The CPLD 120 performs the automatic allocation of bandwidth when external devices are replaced with ones with different bandwidth. Rather than connecting the bandwidth allocation lines directly to a CPU, the computing device 100 connects the bandwidth allocation lines 122 to the CPLD 120 and directs the bandwidth allocation information to the CPLD 120 through the bandwidth allocation lines 122. The CPLD 120 connects and communicates with the PCIe controller 106. The PCIe controller 106 accesses the bandwidth allocation information by communicating with the CPLD 120 using an inter-Integrated Circuit (I2C) bus. For example, the CPLD 120 can receive bandwidth allocation information through the bandwidth allocation lines 122 PRSNT0_[0 . . . 3], PRSNT1_[0 . . . 3], and PRSNT2_[0 . . . 3]. The PCIe controller 106 for the CPU0 can access the bandwidth allocation information from the CPLD 120 using the signal CPLD_I2C0.

The computing device 100 can automatically adapt PCIe bandwidth for replacement of external devices with different bandwidth through a reset of the PCIe controller 106. The CPLD 120 performs the reset of the PCIe controller 106. For example, the CPLD 120 can reset the bandwidth allocation of the PCIe controller 106 through the signals RESET0, RESET1, and RESET2.

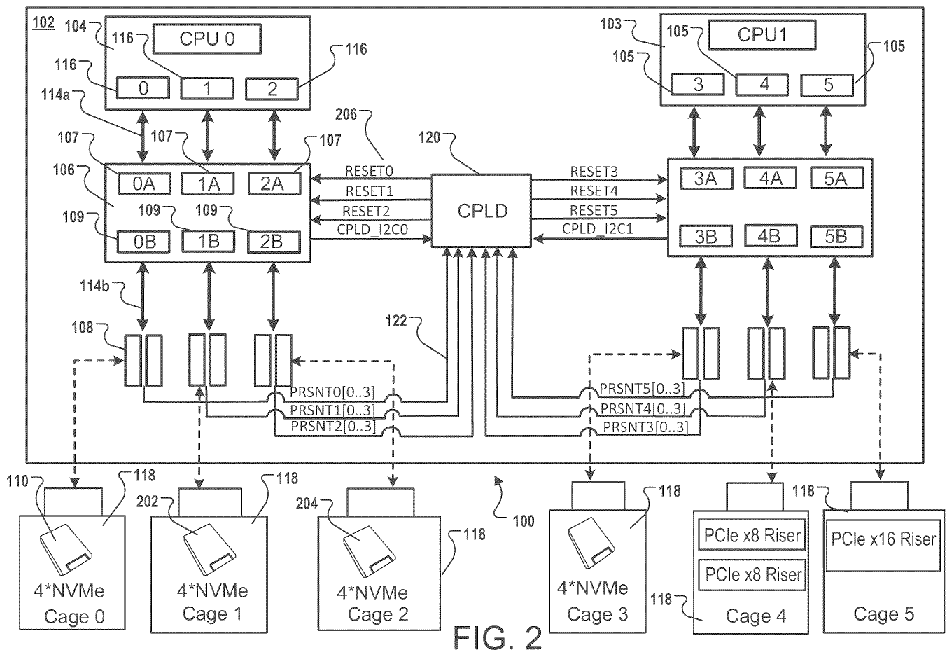

FIG. 2 is a block diagram of the computing device 100 of FIG. 1, with replacement of several external devices, according to an implementation of the present disclosure. For example, a user of the computing device 100 can change the external devices of the computing device 100. In Cage1, two PCIe x8 Riser cards 124 can be replaced with four PCIe x4 NVMe devices 202. In Cage2, one PCIe x16 Riser card 126 can be replaced with four PCIe x4 NVMe devices 204. With the replacement of the external devices, the computing device 100 can reset the bandwidth of the downstream ports 109 of the PCIe controller 106 using the CPLD 120 to adapt to the current external devices in Cage1 and Cage2, without a need to reboot the computing device 100.

The CPLD 120 adapts the downstream side of the PCIe controller 106 to the changes of the external devices. After the replacement of external devices in Cage1 and Cage2, the bandwidth signal in the bandwidth allocation lines 122 indicates that the bandwidth requirements for the present external devices in the cages. The CPLD 120 obtains the present bandwidth signal from the bandwidth allocation lines 122. The CPLD 120 can determine that the present bandwidth signal does not match the previous bandwidth signal before the replacement of the external devices. The CPLD 120 performs a new allocation of the bandwidth for the downstream ports 109 0B, 1B, and 2B of the PCIe controller 106 based on the present bandwidth signals.

For example, for Cage1, the CPLD 120 can determine that the old bandwidth requirement is two x8 bandwidth and the new bandwidth requirement is four x4 bandwidth. For Cage2, the CPLD 120 can determine that the old bandwidth requirement is one x16 bandwidth and the new bandwidth requirement is four x4 bandwidth. The CPLD 120 can perform a new allocation of the bandwidth for the downstream ports 109 0B, 1B, and 2B of the PCIe controller 106 using the RESET signals 206, such as the RESET0, RESET1, and RESET2 signals. After the new allocation, the bandwidth for the port 0B remains four x4 bandwidth, and both bandwidth for the port 1B and 2B are updated to four x4 bandwidth. After the new allocation, the downstream side of the PCIe controller 106 can communicate with the present external devices in the cages.

The bandwidth allocation for the upstream ports 107 0A, 1A, and 2A of the PCIe controller 106 is unchanged. For example, the bandwidth for the upstream ports 107 0A, 1A, and 2A of the PCIe controller remains to be x16. Thus, the PCIe ports 116 of the CPU 104 can perform a hot-addition connection to the upstream ports 107 of the PCIe controller 106 while the power of the system stays on. The PCIe ports 116 of CPU 104 can re-recognize the PCIe controller 106 after the hot-addition is completed, and bandwidth for the PCIe bus 114a remains at the same x16 bandwidth.

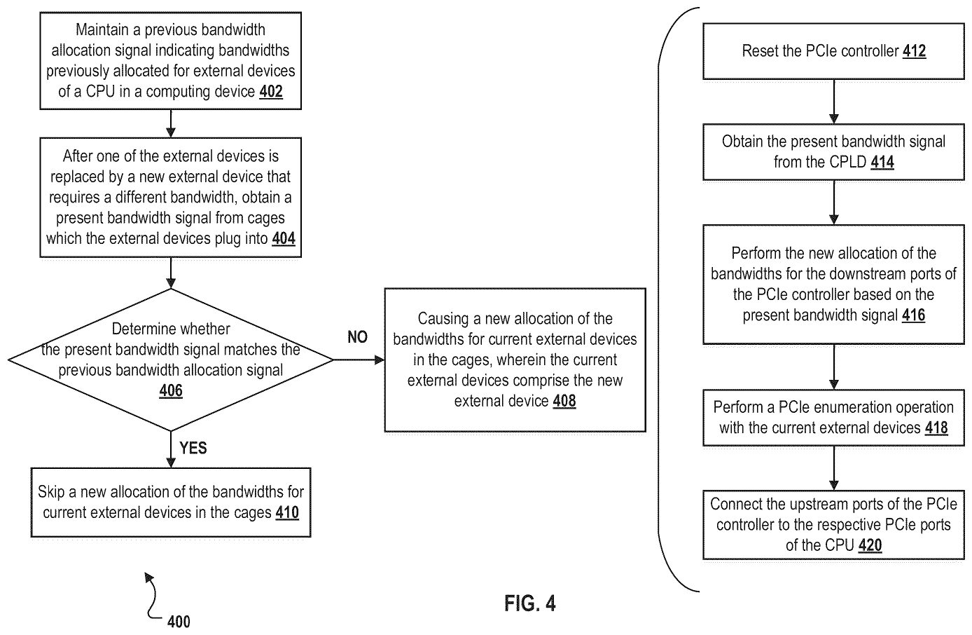

FIG. 4 is a flowchart illustrating an example of a computer-implemented method 400 for external device bandwidth adaptation, according to an implementation of the present disclosure. For clarity of presentation, the description that follows generally describes method 400 in the context of the other figures in this description. However, it will be understood that method 400 can be performed, for example, by any system, environment, software, and hardware, or a combination of systems, environments, software, and hardware, as appropriate. In some implementations, various steps of method 400 can be run in parallel, in combination, in loops, or in any order. In some implementations, the computing device 100 can perform one or more, or all of the processes described in the method 400.

At 402, the system maintains, by a complex programmable logic device (CPLD), a previous bandwidth allocation signal indicating bandwidth previously allocated for external devices of a central processing unit (CPU) in a computing device. The downstream ports of a peripheral component interconnect express (PCIe) controller of the CPU connect to respective cages which the external devices plug into following the previous bandwidth allocation signal. The upstream ports of the PCIe controller connect to respective PCIe ports of the CPU using a fixed allocation of bandwidth. In some implementations, the computing device can include two or more CPUs, and each CPU can have a respective PCIe controller that connects respective cages to the CPU. For example, the CPU0 and CPU1 can have their respective PCIe controllers.

In some implementations, the CPLD can store information of the previous bandwidth allocation in a memory, e.g., in a register of the CPLD. In some implementations, the CPLD can obtain the previous bandwidth allocation signal by accessing the bandwidth currently allocated to the downstream ports of the PCIe controller. In some implementations, the bandwidth allocation information is stored in a memory of the CPLD. For example, the CPLD can obtain the bandwidth currently allocated to the downstream ports 0B, 1B, and 2B, of the PCIe controller through the CPLD_I2C0 signal. In some implementations, the previous bandwidth allocation signal indicates the bandwidth previously allocated for the external devices of the CPU when the computing device was powered on. In some implementations, the previous bandwidth allocation signal can indicate the bandwidth previously allocated for the external devices before a replacement of one or more external devices.

At 404, after one of the external devices is replaced by a new external device that requires a different bandwidth, the system obtains, by the CPLD, a present bandwidth signal from the cages. For example, after an external device in one of the cages is replaced by a new external device, the computing device automatically updates the values of the bandwidth allocation lines according to the bandwidth requirements of the new external device. The CPLD can obtain the present bandwidth signal by reading the updated values of the bandwidth allocation lines.

For example, when there is a need for replacement of an external device of a server, a user can pull a cage out of the server and the PCIe controller can perform a hot-removal action to disconnect from the cage. When the cage of the new external device is plugged back into the server, the CPLD can determine the bandwidth requirement of the new external device from the signal PRSNTx_[0 . . . 3].

At 406, a determination is made as to whether the present bandwidth signal matches the previous bandwidth allocation signal. For example, when the cage of the new external device is plugged back into the server, the CPLD detects the present bandwidth allocation signal PRSNTx_[0 . . . 3] level information and compares the present bandwidth allocation signal with the previous bandwidth allocation signal. If it is determined that the present bandwidth signal does not match the previous bandwidth allocation signal, the method 400 proceeds to 408. Otherwise, if it is determined that the present bandwidth signal matches the previous bandwidth allocation signal, the method 400 proceeds to 410.

At 408, in response to determining that the present bandwidth signal does not match the previous bandwidth allocation signal, the system causes, by the CPLD, a new allocation of the bandwidth for current external devices in the cages. The current external devices can include the new external device. After the new allocation, the downstream ports of the PCIe controller connect to the cages using the new allocation of bandwidth. For example, when the CPLD detects the bandwidth allocation signal PRSNTx_[0 . . . 3] level information is different from the previous bandwidth allocation signal, the system can determine that the bandwidth requirement of the new device inserted is different from the bandwidth allocation of the previous device. In some implementations, the new allocation of the bandwidth for current external devices in the cages can be performed without powering off the computing device.

In some implementations, the step 408 can include one or more of the steps 412, 414, 416, 418, and 420. At 412, the system can reset, by the CPLD, the PCIe controller. In some implementations, resetting the PCIe controller can include disconnecting, by the CPLD, the upstream ports of the PCIe controller from the respective PCIe ports of the CPU. That is, the corresponding CPU PCIe Ports can be hot removed. For example, the CPLD can disconnect the upstream ports 0A, 1A, and 2A of the PCIe controller from the respective PCIe ports of the CPU 104 without powering off or rebooting the computing device.

At 414, the system can obtain, by the PCIe controller, the present bandwidth signal from the CPLD. For example, the PCIe controller 106 can obtain the present bandwidth signal from the CPLD through the I2C bus. At 416, the system can perform, by the PCIe controller, the new allocation of the bandwidth for the downstream ports of the PCIe controller based on the present bandwidth signal. For example, the PCIe controller can allocate bandwidth for the downstream ports 0B, 1B, and 2B according to the CPLD_I2C0 signal or RESET signals obtained from the CPLD.

At 418, the system can perform, by the PCIe controller, a PCIe enumeration operation with the current external devices. For example, the PCIe controller can assign unique identifiers to the cages or the external devices in the cages that the PCIe controller currently connects to through the PCIe bus. After the enumeration, the computing device can communicate with the external devices and can access their functions and features. The CPLD can maintain the present bandwidth signal, and when there is a replacement of another external device, the system can perform the described bandwidth allocation using the present bandwidth signal.

At 420, the system can connect, by the PCIe controller, the upstream ports of the PCIe controller to the respective PCIe ports of the CPU using the fixed allocation of the bandwidth. Because the PCIe ports of the CPU use the fixed allocation of the bandwidth, after configuring the downstream ports of the PCIe controller, the system can hot connect the upstream ports of the PCIe controller to the PCIe ports of the CPU using the same fixed bandwidth. For example, the fixed bandwidth can be x16, and after replacing the external devices in Cage1 and Cage2 and configuring the downstream ports 0B, 1B, and 2B of the PCIe controller, the system can connect the PCIe ports of the CPU and the upstream ports 0A, 1A, and 2A of the PCIe controller using the same x16 bandwidth.

At 410, in response to determining that the present bandwidth signal matches the previous bandwidth allocation signal, the system skips, by the CPLD, a new allocation of the bandwidth for the current external devices in the cages, and the current external devices includes the new external device. The CPLD does not need to perform a new bandwidth allocation for the downstream side of the PCIe controller. The PCIe controller can connect the upstream ports of the PCIe controller to the respective PCIe ports of the CPU using the fixed allocation of the bandwidth, by hot addition (without turning off the power or rebooting). The PCIe controller does not need to perform a new allocation of bandwidth if the CPLD detects that the bandwidth allocation signal PRSNTx_[0 . . . 3] level information is unchanged. For example, the four NVMe devices can be replaced with four PCIe x4 Risers. Because both the four NVMe devices and the four PCIe x4 Risers require the same four x4 bandwidth allocation, the system can determine that the present bandwidth signal matches the previous bandwidth allocation signal. The CPLD can skip a new allocation of bandwidth for the four PCIe x4 Risers in the cages.

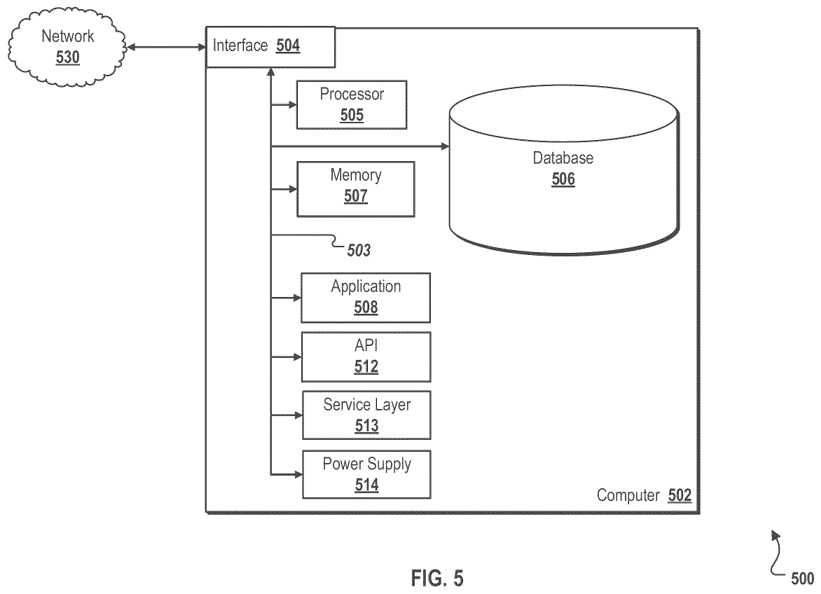

FIG. 5 is a block diagram illustrating an example of a computer-implemented System 500 used to provide computational functionalities associated with described algorithms, methods, functions, processes, flows, and procedures, according to an implementation of the present disclosure. In the illustrated implementation, computer-implemented system 500 includes a Computer 502 and a Network 530.

The illustrated Computer 502 is intended to encompass any computing device, such as a server, desktop computer, laptop/notebook computer, wireless data port, smart phone, personal data assistant (PDA), tablet computer, one or more processors within these devices, or a combination of computing devices, including physical or virtual instances of the computing device, or a combination of physical or virtual instances of the computing device. Additionally, the Computer 502 can include an input device, such as a keypad, keyboard, or touch screen, or a combination of input devices that can accept user information, and an output device that conveys information associated with the operation of the Computer 502, including digital data, visual, audio, another type of information, or a combination of types of information, on a graphical-type user interface (UI) (or GUI) or other UI.

The Computer 502 can serve in a role in a distributed computing system as, for example, a client, network component, a server, or a database or another persistency, or a combination of roles for performing the subject matter described in the present disclosure. The illustrated Computer 502 is communicably coupled with a Network 530. In some implementations, one or more components of the Computer 502 can be configured to operate within an environment, or a combination of environments, including cloud-computing, local, or global.

At a high level, the Computer 502 is an electronic computing device operable to receive, transmit, process, store, or manage data and information associated with the described subject matter. According to some implementations, the Computer 502 can also include or be communicably coupled with a server, such as an application server, e-mail server, web server, caching server, or streaming data server, or a combination of servers.

The Computer 502 can receive requests over Network 530 (for example, from a client software application executing on another Computer 502) and respond to the received requests by processing the received requests using a software application or a combination of software applications. In addition, requests can also be sent to the Computer 502 from internal users (for example, from a command console or by another internal access method), external or third-parties, or other entities, individuals, systems, or computers.

Each of the components of the Computer 502 can communicate using a System Bus 503. In some implementations, any or all of the components of the Computer 502, including hardware, software, or a combination of hardware and software, can interface over the System Bus 503 using an application programming interface (API) 512, a Service Layer 513, or a combination of the API 512 and Service Layer 513. The API 512 can include specifications for routines, data structures, and object classes. The API 512 can be either computer-language independent or dependent and refer to a complete interface, a single function, or even a set of APIs. The Service Layer 513 provides software services to the Computer 502 or other components (whether illustrated or not) that are communicably coupled to the Computer 502. The functionality of the Computer 502 can be accessible for all service consumers using the Service Layer 513. Software services, such as those provided by the Service Layer 513, provide reusable, defined functionalities through a defined interface. For example, the interface can be software written in a computing language (for example JAVA or C++) or a combination of computing languages, and providing data in a particular format (for example, extensible markup language (XML)) or a combination of formats. While illustrated as an integrated component of the Computer 502, alternative implementations can illustrate the API 512 or the Service Layer 513 as stand-alone components in relation to other components of the Computer 502 or other components (whether illustrated or not) that are communicably coupled to the Computer 502. Moreover, any or all parts of the API 512 or the Service Layer 513 can be implemented as a child or a sub-module of another software module, enterprise application, or hardware module without departing from the scope of the present disclosure.

The Computer 502 includes an Interface 504. Although illustrated as a single Interface 504, two or more Interfaces 504 can be used according to particular needs, desires, or particular implementations of the Computer 502. The Interface 504 is used by the Computer 502 for communicating with another computing system (whether illustrated or not) that is communicatively linked to the Network 530 in a distributed environment. Generally, the Interface 504 is operable to communicate with the Network 530 and includes logic encoded in software, hardware, or a combination of software and hardware. More specifically, the Interface 504 can include software supporting one or more communication protocols Is associated with communications such that the Network 530 or hardware of Interface 504 is operable to communicate physical signals within and outside of the illustrated Computer 502.

The Computer 502 includes a Processor 505. Although illustrated as a single Processor 505, two or more Processors 505 can be used according to particular needs, desires, or particular implementations of the Computer 502. Generally, the Processor 505 executes instructions and manipulates data to perform the operations of the Computer 502 and any algorithms, methods, functions, processes, flows, and procedures as described in the present disclosure.

The Computer 502 also includes a Database 506 that can hold data for the Computer 502, another component communicatively linked to the Network 530 (whether illustrated or not), or a combination of the Computer 502 and another component. For example, Database 506 can be an in-memory or conventional database storing data consistent with the present disclosure. In some implementations, Database 506 can be a combination of two or more different database types (for example, a hybrid in-memory and conventional database) according to particular needs, desires, or particular implementations of the Computer 502 and the described functionality. Although illustrated as a single Database 506, two or more databases of similar or differing types can be used according to particular needs, desires, or particular implementations of the Computer 502 and the described functionality. While Database 506 is illustrated as an integral component of the Computer 502, in alternative implementations, Database 506 can be external to the Computer 502. The Database 506 can hold and operate on at least any data type mentioned or any data type consistent with this disclosure.

The Computer 502 also includes a Memory 507 that can hold data for the Computer 502, another component or components communicatively linked to the Network 530 (whether illustrated or not), or a combination of the Computer 502 and another component. Memory 507 can store any data consistent with the present disclosure. In some implementations, Memory 507 can be a combination of two or more different types of memory (for example, a combination of semiconductor and magnetic storage) according to particular needs, desires, or particular implementations of the Computer 502 and the described functionality. Although illustrated as a single Memory 507, two or more Memories 507 or similar or differing types can be used according to particular needs, desires, or particular implementations of the Computer 502 and the described functionality. While Memory 507 is illustrated as an integral component of the Computer 502, in alternative implementations, Memory 507 can be external to the Computer 502.

The Application 508 is an algorithmic software engine providing functionality according to particular needs, desires, or particular implementations of the Computer 502, particularly with respect to functionality described in the present disclosure. For example, Application 508 can serve as one or more components, modules, or applications. Further, although illustrated as a single Application 508, the Application 508 can be implemented as multiple Applications 508 on the Computer 502. In addition, although illustrated as integral to the Computer 502, in alternative implementations, the Application 508 can be external to the Computer 502.

The Computer 502 can also include a Power Supply 514. The Power Supply 514 can include a rechargeable or non-rechargeable battery that can be configured to be either user- or non-user-replaceable. In some implementations, the Power Supply 514 can include power-conversion or management circuits (including recharging, standby, or another power management functionality). In some implementations, the Power Supply 514 can include a power plug to allow the Computer 502 to be plugged into a wall socket or another power source to, for example, power the Computer 502 or recharge a rechargeable battery.

There can be any number of Computers 502 associated with, or external to, a computer system containing Computer 502, each Computer 502 communicating over Network 530. Further, the term “client,” “user,” or other appropriate terminology can be used interchangeably, as appropriate, without departing from the scope of the present disclosure. Moreover, the present disclosure contemplates that many users can use one Computer 502, or that one user can use multiple computers 502.

Described implementations of the subject matter can include one or more features, alone or in combination.

For example, in a first implementation, a computer-implemented method, comprising: maintaining, by a complex programmable logic device (CPLD), a previous bandwidth allocation signal indicating bandwidth previously allocated for external devices of a central processing unit (CPU) in a computing device, wherein downstream ports of a peripheral component interconnect express (PCIe) controller of the CPU connect to respective cages which the external devices plug into following the previous bandwidth allocation signal, and upstream ports of the PCIe controller connect to respective PCIe ports of the CPU using a fixed allocation of bandwidth; after one of the external devices is replaced by a new external device that requires a different bandwidth, obtaining, by the CPLD, a present bandwidth signal from the cages; determining, by the CPLD, whether the present bandwidth signal matches the previous bandwidth allocation signal; and in response to determining that the present bandwidth signal does not match the previous bandwidth allocation signal, causing, by the CPLD, a new allocation of the bandwidth for current external devices in the cages, wherein the current external devices comprise the new external device, wherein the downstream ports of the PCIe controller connect to the cages using the new allocation of bandwidth.

The foregoing and other described implementations can each, optionally, include one or more of the following features:

A first feature, combinable with any of the following features, wherein causing, by the CPLD, the new allocation of the bandwidth for the current external devices in the cages comprises: resetting, by the CPLD, the PCIe controller; obtaining, by the PCIe controller, the present bandwidth signal from the CPLD; performing, by the PCIe controller, the new allocation of the bandwidth for the downstream ports of the PCIe controller based on the present bandwidth signal; performing, by the PCIe controller, a PCIe enumeration operation with the current external devices; and connecting, by the PCIe controller, the upstream ports of the PCIe controller to the respective PCIe ports of the CPU using the fixed allocation of the bandwidth.

A second feature, combinable with any of the previous or following features, wherein resetting the PCIe controller comprises disconnecting, by the CPLD, the upstream ports of the PCIe controller from the respective PCIe ports of the CPU.

A third feature, combinable with any of the previous or following features, comprising: after one of the external devices is replaced by a second new external device that requires a same bandwidth, obtaining, by the CPLD, a second present bandwidth signal from the cages; determining, by the CPLD, whether the second present bandwidth signal matches the previous bandwidth allocation signal; and in response to determining that the second present bandwidth signal matches the previous bandwidth allocation signal, skipping, by the CPLD, a second new allocation of the bandwidth for second current external devices in the cages, wherein the second current external devices comprise the second new external device.

A fourth feature, combinable with any of the previous or following features, wherein the computing device comprises two or more CPUs, and each CPU has a respective PCIe controller that connects respective cages to the CPU.

A fifth feature, combinable with any of the previous or following features, wherein the previous bandwidth allocation signal indicates the bandwidth previously allocated for the external devices of the CPU when the computing device was powered on.

A sixth feature, combinable with any of the previous or following features, wherein the new allocation of the bandwidth for the current external devices in the cages is performed without powering off the computing device.

A seventh feature, combinable with any of the previous or following features, comprising setting the previous bandwidth allocation signal to the present bandwidth signal.

In a second implementation, a computing device, comprising: a central processing unit (CPU), cages which external devices plug into, a peripheral component interconnect express (PCIe) controller of the CPU, wherein downstream ports of the PCIe controller connect to the cages, and upstream ports of the PCIe controller connect to respective PCIe ports of the CPU using a fixed allocation of bandwidth, and a complex programmable logic device (CPLD) programmed to perform operations comprising: maintaining a previous bandwidth allocation signal indicating bandwidth previously allocated for the external devices of the CPU, wherein the downstream ports of the PCIe controller connect to the cages following the previous bandwidth allocation signal; after one of the external devices is replaced by a new external device that requires a different bandwidth, obtaining a present bandwidth signal from the cages; determining whether the present bandwidth signal matches the previous bandwidth allocation signal; and in response to determining that the present bandwidth signal does not match the previous bandwidth allocation signal, causing a new allocation of bandwidth for current external devices in the cages, wherein the current external devices comprise the new external device, wherein the downstream ports of the PCIe controller connect to the cages using the new allocation of bandwidth.

The foregoing and other described implementations can each, optionally, include one or more of the following features:

A first feature, combinable with any of the following features, wherein causing, by the CPLD, the new allocation of the bandwidth for the current external devices in the cages comprises: resetting, by the CPLD, the PCIe controller; obtaining, by the PCIe controller, the present bandwidth signal from the CPLD; performing, by the PCIe controller, the new allocation of the bandwidth for the downstream ports of the PCIe controller based on the present bandwidth signal; performing, by the PCIe controller, a PCIe enumeration operation with the current external devices; and connecting, by the PCIe controller, the upstream ports of the PCIe controller to the respective PCIe ports of the CPU using the fixed allocation of the bandwidth.

A second feature, combinable with any of the previous or following features, wherein resetting the PCIe controller comprises disconnecting, by the CPLD, the upstream ports of the PCIe controller from the respective PCIe ports of the CPU.

A third feature, combinable with any of the previous or following features, wherein the operations comprise: after one of the external devices is replaced by a second new external device that requires a same bandwidth, obtaining, by the CPLD, a second present bandwidth signal from the cages; determining, by the CPLD, whether the second present bandwidth signal matches the previous bandwidth allocation signal; and in response to determining that the second present bandwidth signal matches the previous bandwidth allocation signal, skipping, by the CPLD, a second new allocation of the bandwidth for second current external devices in the cages, wherein the second current external devices comprise the second new external device.

In a third implementation, a non-transitory, computer-readable medium storing one or more instructions executable by a computer system to perform one or more operations, comprising: maintaining, by a complex programmable logic device (CPLD), a previous bandwidth allocation signal indicating bandwidth previously allocated for external devices of a central processing unit (CPU) in a computing device, wherein downstream ports of a peripheral component interconnect express (PCIe) controller of the CPU connect to respective cages which the external devices plug into following the previous bandwidth allocation signal, and upstream ports of the PCIe controller connect to respective PCIe ports of the CPU using a fixed allocation of bandwidth; after one of the external devices is replaced by a new external device that requires a different bandwidth, obtaining, by the CPLD, a present bandwidth signal from the cages; determining, by the CPLD, whether the present bandwidth signal matches the previous bandwidth allocation signal; and in response to determining that the present bandwidth signal does not match the previous bandwidth allocation signal, causing, by the CPLD, a new allocation of the bandwidth for current external devices in the cages, wherein the current external devices comprise the new external device, wherein the downstream ports of the PCIe controller connect to the cages using the new allocation of bandwidth.

The foregoing and other described implementations can each, optionally, include one or more of the following features:

A first feature, combinable with any of the following features, wherein causing, by the CPLD, the new allocation of the bandwidth for the current external devices in the cages comprises: resetting, by the CPLD, the PCIe controller; obtaining, by the PCIe controller, the present bandwidth signal from the CPLD; performing, by the PCIe controller, the new allocation of the bandwidth for the downstream ports of the PCIe controller based on the present bandwidth signal; performing, by the PCIe controller, a PCIe enumeration operation with the current external devices; and connecting, by the PCIe controller, the upstream ports of the PCIe controller to the respective PCIe ports of the CPU using the fixed allocation of the bandwidth.

A second feature, combinable with any of the previous or following features, wherein resetting the PCIe controller comprises disconnecting, by the CPLD, the upstream ports of the PCIe controller from the respective PCIe ports of the CPU.

A third feature, combinable with any of the previous or following features, wherein the operations comprise: after one of the external devices is replaced by a second new external device that requires a same bandwidth, obtaining, by the CPLD, a second present bandwidth signal from the cages; determining, by the CPLD, whether the second present bandwidth signal matches the previous bandwidth allocation signal; and in response to determining that the second present bandwidth signal matches the previous bandwidth allocation signal, skipping, by the CPLD, a second new allocation of the bandwidth for second current external devices in the cages, wherein the second current external devices comprise the second new external device.

A fourth feature, combinable with any of the previous or following features, wherein the computing device comprises two or more CPUs, and each CPU has a respective PCIe controller that connects respective cages to the CPU.

A fifth feature, combinable with any of the previous or following features, wherein the previous bandwidth allocation signal indicates the bandwidth previously allocated for the external devices of the CPU when the computing device was powered on.

A sixth feature, combinable with any of the previous or following features, wherein the new allocation of the bandwidth for the current external devices in the cages is performed without powering off the computing device.

A seventh feature, combinable with any of the previous or following features, wherein the operations comprise setting the previous bandwidth allocation signal to the present bandwidth signal.

Implementations of the subject matter and the functional operations described in this specification can be implemented in digital electronic circuitry, in tangibly embodied computer software or firmware, in computer hardware, including the structures disclosed in this specification and their structural equivalents, or in combinations of one or more of them. Software implementations of the described subject matter can be implemented as one or more computer programs, that is, one or more modules of computer program instructions encoded on a tangible, non-transitory, computer-readable medium for execution by, or to control the operation of, a computer or computer-implemented system. Alternatively, or additionally, the program instructions can be encoded in/on an artificially generated propagated signal, for example, a machine-generated electrical, optical, or electromagnetic signal that is generated to encode information for transmission to a receiver apparatus for execution by a computer or computer-implemented system. The computer-storage medium can be a machine-readable storage device, a machine-readable storage substrate, a random or serial access memory device, or a combination of computer-storage mediums. Configuring one or more computers means that the one or more computers have installed hardware, firmware, or software (or combinations of hardware, firmware, and software) so that when the software is executed by the one or more computers, particular computing operations are performed. The computer storage medium is not, however, a propagated signal.

The term “real-time,” “real time,” “realtime,” “real (fast) time (RFT),” “near (ly) real-time (NRT),” “quasi real-time,” or similar terms (as understood by one of ordinary skill in the art), means that an action and a response are temporally proximate such that an individual perceives the action and the response occurring substantially simultaneously. For example, the time difference for a response to display (or for an initiation of a display) of data following the individual's action to access the data can be less than 1 millisecond (ms), less than 1 second(s), or less than 5 s. While the requested data need not be displayed (or initiated for display) instantaneously, it is displayed (or initiated for display) without any intentional delay, taking into account processing limitations of a described computing system and time required to, for example, gather, accurately measure, analyze, process, store, or transmit the data.

The terms “data processing apparatus,” “computer,” “computing device,” or “electronic computer device” (or an equivalent term as understood by one of ordinary skill in the art) refer to data processing hardware and encompass all kinds of apparatuses, devices, and machines for processing data, including by way of example, a programmable processor, a computer, or multiple processors or computers. The computer can also be, or further include special-purpose logic circuitry, for example, a central processing unit (CPU), a field-programmable gate array (FPGA), or an application-specific integrated circuit (ASIC). In some implementations, the computer or computer-implemented system or special-purpose logic circuitry (or a combination of the computer or computer-implemented system and special-purpose logic circuitry) can be hardware- or software-based (or a combination of both hardware- and software-based). The computer can optionally include code that creates an execution environment for computer programs, for example, code that constitutes processor firmware, a protocol stack, a database management system, an operating system, or a combination of execution environments. The present disclosure contemplates the use of a computer or computer-implemented system with an operating system, for example LINUX, UNIX, WINDOWS, MAC OS, ANDROID, or IOS, or a combination of operating systems.

A computer program, which can also be referred to or described as a program, software, a software application, a unit, a module, a software module, a script, code, or other component can be written in any form of programming language, including compiled or interpreted languages, or declarative or procedural languages, and it can be deployed in any form, including, for example, as a stand-alone program, module, component, or subroutine, for use in a computing environment. A computer program can, but need not, correspond to a file in a file system. A program can be stored in a portion of a file that holds other programs or data, for example, one or more scripts stored in a markup language document, in a single file dedicated to the program in question, or in multiple coordinated files, for example, files that store one or more modules, sub-programs, or portions of code. A computer program can be deployed to be executed on one computer or on multiple computers that are located at one site or distributed across multiple sites and interconnected by a communication network.

While portions of the programs illustrated in the various figures can be illustrated as individual components, such as units or modules, that implement described features and functionality using various objects, methods, or other processes, the programs can instead include a number of sub-units, sub-modules, third-party services, components, libraries, and other components, as appropriate. Conversely, the features and functionality of various components can be combined into single components, as appropriate. Thresholds used to make computational determinations can be statically, dynamically, or both statically and dynamically determined.

Described methods, processes, or logic flows represent one or more examples of functionality consistent with the present disclosure and are not intended to limit the disclosure to the described or illustrated implementations, but to be accorded the widest scope consistent with described principles and features. The described methods, processes, or logic flows can be performed by one or more programmable computers executing one or more computer programs to perform functions by operating on input data and generating output data. The methods, processes, or logic flows can also be performed by, and computers can also be implemented as, special-purpose logic circuitry, for example, a CPU, an FPGA, or an ASIC.

Computers for the execution of a computer program can be based on general or special-purpose microprocessors, both, or another type of CPU. Generally, a CPU will receive instructions and data from and write to a memory. The essential elements of a computer are a CPU, for performing or executing instructions, and one or more memory devices for storing instructions and data. Generally, a computer will also include, or be operatively coupled to, receive data from or transfer data to, or both, one or more mass storage devices for storing data, for example, magnetic, magneto-optical disks, or optical disks. However, a computer need not have such devices. Moreover, a computer can be embedded in another device, for example, a mobile telephone, a personal digital assistant (PDA), a mobile audio or video player, a game console, a global positioning system (GPS) receiver, or a portable memory storage device, for example, a universal serial bus (USB) flash drive, to name just a few.

Non-transitory computer-readable media for storing computer program instructions and data can include all forms of permanent/non-permanent or volatile/non-volatile memory, media and memory devices, including by way of example semiconductor memory devices, for example, random access memory (RAM), read-only memory (ROM), phase change memory (PRAM), static random access memory (SRAM), dynamic random access memory (DRAM), erasable programmable read-only memory (EPROM), electrically erasable programmable read-only memory (EEPROM), and flash memory devices; magnetic devices, for example, tape, cartridges, cassettes, internal/removable disks; magneto-optical disks; and optical memory devices, for example, digital versatile/video disc (DVD), compact disc (CD)-ROM, DVD+/−R, DVD-RAM, DVD-ROM, high-definition/density (HD)-DVD, and BLU-RAY/BLU-RAY DISC (BD), and other optical memory technologies. The memory can store various objects or data, including caches, classes, frameworks, applications, modules, backup data, jobs, web pages, web page templates, data structures, database tables, repositories storing dynamic information, or other appropriate information including any parameters, variables, algorithms, instructions, rules, constraints, or references. Additionally, the memory can include other appropriate data, such as logs, policies, security or access data, or reporting files. The processor and the memory can be supplemented by, or incorporated in, special-purpose logic circuitry.

To provide for interaction with a user, implementations of the subject matter described in this specification can be implemented on a computer having a display device, for example, a cathode ray tube (CRT), liquid crystal display (LCD), light emitting diode (LED), or plasma monitor, for displaying information to the user and a keyboard and a pointing device, for example, a mouse, trackball, or trackpad by which the user can provide input to the computer. Input can also be provided to the computer using a touchscreen, such as a tablet computer surface with pressure sensitivity or a multi-touch screen using capacitive or electric sensing. Other types of devices can be used to interact with the user. For example, feedback provided to the user can be any form of sensory feedback (such as, visual, auditory, tactile, or a combination of feedback types). Input from the user can be received in any form, including acoustic, speech, or tactile input. In addition, a computer can interact with the user by sending documents to and receiving documents from a client computing device that is used by the user (for example, by sending web pages to a web browser on a user's mobile computing device in response to requests received from the web browser).

The term “graphical user interface (GUI) can be used in the singular or the plural to describe one or more graphical user interfaces and each of the displays of a particular graphical user interface. Therefore, a GUI can represent any graphical user interface, including but not limited to, a web browser, a touch screen, or a command line interface (CLI) that processes information and efficiently presents the information results to the user. In general, a GUI can include a number of user interface (UI) elements, some or all associated with a web browser, such as interactive fields, pull-down lists, and buttons. These and other UI elements can be related to or represent the functions of the web browser.

Implementations of the subject matter described in this specification can be implemented in a computing system that includes a back-end component, for example, as a data server, or that includes a middleware component, for example, an application server, or that includes a front-end component, for example, a client computer having a graphical user interface or a Web browser through which a user can interact with an implementation of the subject matter described in this specification, or any combination of one or more such back-end, middleware, or front-end components. The components of the system can be interconnected by any form or medium of wireline or wireless digital data communication (or a combination of data communication), for example, a communication network. Examples of communication networks include a local area network (LAN), a radio access network (RAN), a metropolitan area network (MAN), a wide area network (WAN), Worldwide Interoperability for Microwave Access (WIMAX), a wireless local area network (WLAN) using, for example, 802.11x or other protocols, all or a portion of the Internet, another communication network, or a combination of communication networks. The communication network can communicate with, for example, Internet Protocol (IP) packets, frame relay frames, Asynchronous Transfer Mode (ATM) cells, voice, video, data, or other information between network nodes.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of any inventive concept or on the scope of what can be claimed, but rather as descriptions of features that can be specific to particular implementations of particular inventive concepts. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features can be described as acting in certain combinations and even initially claimed as such, one or more features from a claimed combination can, in some cases, be excised from the combination, and the claimed combination can be directed to a sub-combination or variation of a sub-combination.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations can be considered optional), to achieve desirable results. In certain circumstances, multitasking or parallel processing (or a combination of multitasking and parallel processing) can be advantageous and performed as deemed appropriate.

The separation or integration of various system modules and components in the previously described implementations should not be understood as requiring such separation or integration in all implementations, and it should be understood that the described program components and systems can generally be integrated together in a single software product or packaged into multiple software products.

Accordingly, the previously described example implementations do not define or constrain the present disclosure. Other changes, substitutions, and alterations are also possible without departing from the scope of the present disclosure.

Furthermore, any claimed implementation is considered to be applicable to at least a computer-implemented method; a non-transitory, computer-readable medium storing computer-readable instructions to perform the computer-implemented method; and a computer system comprising a computer memory interoperably coupled with a hardware processor configured to perform the computer-implemented method or the instructions stored on the non-transitory, computer-readable medium.

What is claimed is:

1. A computer-implemented method, comprising:
maintaining, by a complex programmable logic device (CPLD), a previous bandwidth allocation signal indicating bandwidth previously allocated for external devices of a central processing unit (CPU) in a computing device, wherein downstream ports of a peripheral component interconnect express (PCIe) controller of the CPU connect to respective cages which the external devices plug into following the previous bandwidth allocation signal, and upstream ports of the PCIe controller connect to respective PCIe ports of the CPU using a fixed allocation of bandwidth;
after one of the external devices is replaced by a new external device that requires a different bandwidth, obtaining, by the CPLD, a present bandwidth signal from the cages;
determining, by the CPLD, whether the present bandwidth signal matches the previous bandwidth allocation signal; and
in response to determining that the present bandwidth signal does not match the previous bandwidth allocation signal, causing, by the CPLD, a new allocation of the bandwidth for current external devices in the cages, wherein the current external devices comprise the new external device, wherein the downstream ports of the PCIe controller connect to the cages using the new allocation of bandwidth.

2. The computer-implemented method of claim 1, wherein causing, by the CPLD, the new allocation of the bandwidth for the current external devices in the cages comprises:
resetting, by the CPLD, the PCIe controller;
obtaining, by the PCIe controller, the present bandwidth signal from the CPLD;
performing, by the PCIe controller, the new allocation of the bandwidth for the downstream ports of the PCIe controller based on the present bandwidth signal;
performing, by the PCIe controller, a PCIe enumeration operation with the current external devices; and
connecting, by the PCIe controller, the upstream ports of the PCIe controller to the respective PCIe ports of the CPU using the fixed allocation of the bandwidth.

3. The computer-implemented method of claim 2, wherein resetting the PCIe controller comprises disconnecting, by the CPLD, the upstream ports of the PCIe controller from the respective PCIe ports of the CPU.

4. The computer-implemented method of claim 1, comprising:
after one of the external devices is replaced by a second new external device that requires a same bandwidth, obtaining, by the CPLD, a second present bandwidth signal from the cages;
determining, by the CPLD, whether the second present bandwidth signal matches the previous bandwidth allocation signal; and
in response to determining that the second present bandwidth signal matches the previous bandwidth allocation signal, skipping, by the CPLD, a second new allocation of the bandwidth for second current external devices in the cages, wherein the second current external devices comprise the second new external device.

5. The computer-implemented method of claim 1, wherein the computing device comprises two or more CPUs, and each CPU has a respective PCIe controller that connects respective cages to the CPU.

6. The computer-implemented method of claim 1, wherein the previous bandwidth allocation signal indicates the bandwidth previously allocated for the external devices of the CPU when the computing device was powered on.

7. The computer-implemented method of claim 1, wherein the new allocation of the bandwidth for the current external devices in the cages is performed without powering off the computing device.

8. The computer-implemented method of claim 1, comprising setting the previous bandwidth allocation signal to the present bandwidth signal.

9. A computing device, comprising:
a central processing unit (CPU),
cages which external devices plug into,
a peripheral component interconnect express (PCIe) controller of the CPU, wherein downstream ports of the PCIe controller connect to the cages, and upstream ports of the PCIe controller connect to respective PCIe ports of the CPU using a fixed allocation of bandwidth, and
a complex programmable logic device (CPLD) programmed to perform operations comprising:
maintaining a previous bandwidth allocation signal indicating bandwidth previously allocated for the external devices of the CPU, wherein the downstream ports of the PCIe controller connect to the cages following the previous bandwidth allocation signal;
after one of the external devices is replaced by a new external device that requires a different bandwidth, obtaining a present bandwidth signal from the cages;
determining whether the present bandwidth signal matches the previous bandwidth allocation signal; and
in response to determining that the present bandwidth signal does not match the previous bandwidth allocation signal, causing a new allocation of bandwidth for current external devices in the cages, wherein the current external devices comprise the new external device, wherein the downstream ports of the PCIe controller connect to the cages using the new allocation of bandwidth.

10. The computing device of claim 9, wherein causing the new allocation of the bandwidth for the current external devices in the cages comprises:
resetting, by the CPLD, the PCIe controller;
obtaining, by the PCIe controller, the present bandwidth signal from the CPLD;
performing, by the PCIe controller, the new allocation of the bandwidth for the downstream ports of the PCIe controller based on the present bandwidth signal;
performing, by the PCIe controller, a PCIe enumeration operation with the current external devices; and
connecting, by the PCIe controller, the upstream ports of the PCIe controller to the respective PCIe ports of the CPU using the fixed allocation of the bandwidth.

11. The computing device of claim 10, wherein resetting the PCIe controller comprises disconnecting, by the CPLD, the upstream ports of the PCIe controller from the respective PCIe ports of the CPU.

12. The computing device of claim 9, wherein the operations comprise:
after one of the external devices is replaced by a second new external device that requires a same bandwidth, obtaining, by the CPLD, a second present bandwidth signal from the cages;
determining, by the CPLD, whether the second present bandwidth signal matches the previous bandwidth allocation signal; and
in response to determining that the second present bandwidth signal matches the previous bandwidth allocation signal, skipping, by the CPLD, a second new allocation of the bandwidth for second current external devices in the cages, wherein the second current external devices comprise the second new external device.

13. A non-transitory, computer-readable medium storing one or more instructions executable by a computer system to perform one or more operations, comprising:
maintaining, by a complex programmable logic device (CPLD), a previous bandwidth allocation signal indicating bandwidth previously allocated for external devices of a central processing unit (CPU) in a computing device, wherein downstream ports of a peripheral component interconnect express (PCIe) controller of the CPU connect to respective cages which the external devices plug into following the previous bandwidth allocation signal, and upstream ports of the PCIe controller connect to respective PCIe ports of the CPU using a fixed allocation of bandwidth;
after one of the external devices is replaced by a new external device that requires a different bandwidth, obtaining, by the CPLD, a present bandwidth signal from the cages;
determining, by the CPLD, whether the present bandwidth signal matches the previous bandwidth allocation signal; and
in response to determining that the present bandwidth signal does not match the previous bandwidth allocation signal, causing, by the CPLD, a new allocation of the bandwidth for current external devices in the cages, wherein the current external devices comprise the new external device, wherein the downstream ports of the PCIe controller connect to the cages using the new allocation of bandwidth.

14. The computer-readable medium of claim 13, wherein causing, by the CPLD, the new allocation of the bandwidth for the current external devices in the cages comprises:
resetting, by the CPLD, the PCIe controller;
obtaining, by the PCIe controller, the present bandwidth signal from the CPLD;
performing, by the PCIe controller, the new allocation of the bandwidth for the downstream ports of the PCIe controller based on the present bandwidth signal;
performing, by the PCIe controller, a PCIe enumeration operation with the current external devices; and
connecting, by the PCIe controller, the upstream ports of the PCIe controller to the respective PCIe ports of the CPU using the fixed allocation of the bandwidth.

15. The computer-readable medium of claim 14, wherein resetting the PCIe controller comprises disconnecting, by the CPLD, the upstream ports of the PCIe controller from the respective PCIe ports of the CPU.

16. The computer-readable medium of claim 13, wherein the operations comprise:
after one of the external devices is replaced by a second new external device that requires a same bandwidth, obtaining, by the CPLD, a second present bandwidth signal from the cages;
determining, by the CPLD, whether the second present bandwidth signal matches the previous bandwidth allocation signal; and
in response to determining that the second present bandwidth signal matches the previous bandwidth allocation signal, skipping, by the CPLD, a second new allocation of the bandwidth for second current external devices in the cages, wherein the second current external devices comprise the second new external device.

17. The computer-readable medium of claim 13, wherein the computing device comprises two or more CPUs, and each CPU has a respective PCIe controller that connects respective cages to the CPU.

18. The computer-readable medium of claim 13, wherein the previous bandwidth allocation signal indicates the bandwidth previously allocated for the external devices of the CPU when the computing device was powered on.

19. The computer-readable medium of claim 13, wherein the new allocation of the bandwidth for the current external devices in the cages is performed without powering off the computing device.

20. The computer-readable medium of claim 13, wherein the operations comprise setting the previous bandwidth allocation signal to the present bandwidth signal.
